(19) United States
(12) Patent Application Publication
(10) Pub. No.: US 2019/0340850 A1
(43) Pub. Date: Nov. 7, 2019

(54) Method and Terminal For Controlling the Establishment of a Vehicle Accident Report

(71) Applicant: PSA AUTOMOBILES S.A., Poissy (FR)

(72) Inventors: Pascal CHIRON, Clamart (FR); Antonio Eduardo FERNANDEZ, Vigo (ES); El Khamis KADIRI, Neauphle Le Chateau (FR)

(73) Assignee: PSA Automobiles S.A., Poissy (FR)

(21) Appl. No.: 15/779,201

(22) PCT Filed: Nov. 18, 2016
(86) PCT No.: PCT/FR2016/053023

§ 371 Date: May 25, 2018

(30) Foreign Application Priority Data
Nov. 26, 2015 (FR) 1561440

(51) Int. Cl. G07C 5/08; H04Q 9/00; H04L 29/08; H04W 4/44; H04W 4/90; H04W 12/00; G07C 5/00

(52) U.S. Cl. CPC G07C 5/0816; H04Q 9/00; H04L 67/12; H04W 4/44; H04L 63/0428; H04W 12/0017; G07C 5/008; G07C 5/085; H04W 4/90

(57) ABSTRACT

The invention relates to a method, implemented by a terminal, for commanding the establishment of a vehicle accident report, from a telematic computer of the vehicle, characterized in that it comprises the steps of: subscribing, from the telematic computer of the vehicle, to a data publication service, for at least one datum representing a vehicle parameter; repeatedly receiving values for the datum representing a vehicle parameter; determining from the received values, whether the vehicle has been involved in an accident; if the vehicle has been involved in an accident, transmitting to the telematic computer an accident report request; receiving an accident report signed and encrypted by the telematic computer; transmitting the signed and encrypted accident report to a remote server.

### CROSS-REFERENCE TO RELATED APPLICATIONS

This application derives and claims priority from International Application PCT/FR2016/053023, filed Nov. 18, 2016, and published under International Publication Number WO2017/089684, which claims priority to French App. No. 1561440, filed Nov. 26, 2015, and which is hereby incorporated by reference.

### BACKGROUND

The invention relates to the establishment of a vehicle diagnostic report, in particular, after an accident.

Document US2015/0120082 discloses a system enabling an accident report to be established. This system implements a telematic module of a vehicle communicating with a mobile terminal. The mobile terminal is used to communicate data to a remote server. However there is no provision to ensure the integrity of the transmitted data. A transmission error or a malicious act may lead to a change in the accident data without the possibility of realizing that this has occurred.

### SUMMARY

The invention therefore aims to resolve the above problem by proposing a method and a device for automatically commanding the establishment a report when an accident occurs and transmitting this report reliably and securely.

More precisely, it offers for this purpose a method, implemented by a terminal, for commanding the establishment of a vehicle accident report, from a telematic computer of the vehicle, characterized in that it comprises the steps of:
Subscribing, from the telematic computer of the vehicle, to a data publication service, for at least one datum representing a vehicle parameter,
Repeatedly receiving values for the datum representing a vehicle parameter,
Determining, from the received values, whether the vehicle has been involved in an accident,
If the vehicle has been involved in an accident, transmitting to the telematic computer an accident report request,
Receiving an accident report signed and encrypted by the telematic computer,
Transmitting the signed and encrypted accident report to a remote server.

The establishment of a report signed and encrypted by the vehicle computer enables a reliable accident report to be established, the data of which correspond exactly to those recorded by the vehicle's telematic computer. Such a report can be helpful in understanding the circumstances of the accident.

Advantageously, the terminal comprises a memory in which is stored a list of predefined tests, which relate to data representing a vehicle parameter. The step of determining whether the vehicle has been involved in an accident comprises a step of determining whether at least one of the tests is verified or if a combination of tests is verified.

Advantageously, the data representing a vehicle parameter comprises at least one of the following data: a status of an airbag of the vehicle, a status of an electronic stability program of the vehicle, a location of the vehicle, a timestamp indicating the moment of activation of the airbag or of the electronic stability program, a mileage, a log of alerts, fault codes, a steering wheel angle and a pressure on the brake pedal.

Advantageously, the predefined condition list includes at least one of the following conditions:
the vehicle airbag is deployed,
the pressure on the brake pedal is greater than a first predetermined threshold,
the speed variation is greater than a second predetermined threshold,
the variation of the steering wheel angle is greater than a third predetermined threshold.

Advantageously, the method for commanding the establishment of an accident report also comprises a step of receiving a user request, an accident report and, in response, sending, to the telematic computer, an accident report request.

Advantageously, the method for commanding the establishment of an accident report also comprises, if, during the step of determining whether an accident has occurred, at least one of the tests is evaluated positively, the recording of an event in an event log, indicating the test having been evaluated positively.

Advantageously, the method for commanding the establishment of an accident report also comprises a step of receiving the decrypted accident report from the server.

Advantageously, the accident report includes at least one of the following data:
a log of alerts to identify problems after the accident,
an overall check of the vehicle including the status of the openings and the fluid level,
vehicle fault data,
images captured by a camera mounted inside the vehicle.

Also disclosed is a terminal for commanding the establishment of a vehicle accident report characterized in that the terminal comprises:
means for subscribing, in a telematic computer of the vehicle, to a data publication service, for at least one datum representing a vehicle parameter,
means for determining whether the vehicle has been involved in an accident based on the values received,
means for sending, to the telematic computer, an accident report request, if the vehicle has been involved in an accident,
means for receiving an accident report signed and encrypted by the telematic computer,
means for transmitting the signed and encrypted accident report to a remote server.

Also disclosed is a system for establishing a vehicle accident report characterized in that the system comprises a telematic computer onboard the vehicle capable of regularly transmitting data, a remote server, and a terminal capable of communicating with the telematic computer and with the remote server, the system being characterized in that:
the telematic computer is capable of transmitting a signed and encrypted accident report;
the terminal is a terminal as described above.

### DESCRIPTION OF THE DRAWINGS

Further features and advantages of the invention will emerge from the following detailed description and accompanying drawings, in which:

FIG. 1 shows an example of a system for establishing a vehicle accident report; and

FIG. 2 shows a flowchart representing the method for commanding the establishment of an accident report.

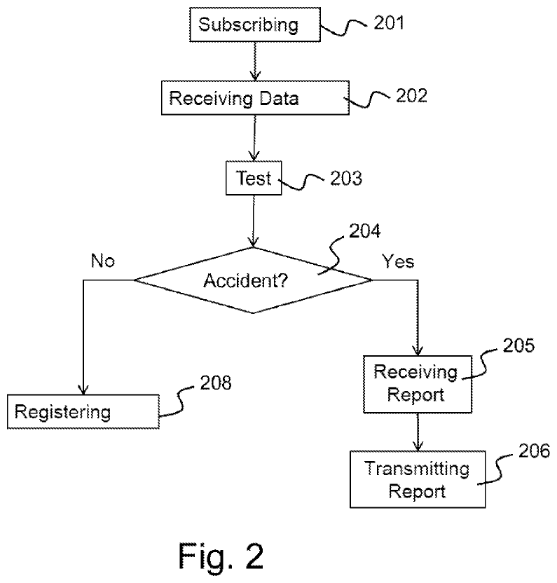

The accompanying drawings may serve not only to complete the invention, but also to contribute to its definition, if necessary.

### DETAILED DESCRIPTION

The invention relates to an application running on a nomadic device (also called a terminal) which automatically establishes a report describing the status of the vehicle after an accident. The occurrence of an accident is determined on the basis of relevant data retrieved from the vehicle.

The accident report describes the vehicle faults that arise after an accident. The report can also incorporate images captured by the vehicle's onboard camera(s). The report provides clarification regarding the causes of an accident, delimits vehicle faults or problems connected with the accident and can potentially provide an initial estimate of the repair costs.

The vehicle has means for certifying the data recorded before, during, or after an accident. An onboard computer is provided with a certificate that guarantees the integrity of the transmitted data. These data are then accessible with the guarantee that the information has not been manipulated.

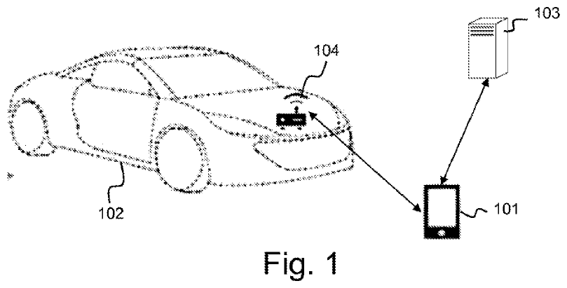

Referring to FIG. 1, a system for establishing a vehicle accident report comprises at least one terminal 101, one vehicle 102 and one central server 103.

Hereinafter, by way of a non-limiting example, the terminal 101 is deemed to be a smartphone. But the invention is not limited to this example. Indeed, the terminal 101 may be a laptop computer, a touchscreen tablet or other connected object (i.e. capable of exchanging data via a wireless or wired connection). This mobile equipment belongs, for example, to the driver of a vehicle or one of the passengers of the vehicle. This equipment 101 comprises at least one processor (or Central Processor Unit (CPU)), a display means (such as a screen) and a designation means (for example a touchscreen). The terminal 101 also comprises means for communicating with a remote network, such as the Internet, comprising shared computing resources. This communication means is, for example, a connection to a telecommunications network of the 2G/3G/4G type, and means for communicating with the telematic computer 104 on board the vehicle 102, for example of the WiFi, Bluetooth or Near Field Communication (NFC) type.

The terminal 101 also comprises:
means for subscribing, in a telematic computer of the vehicle, to a data publication service, for at least one datum representing a parameter of the vehicle 102,
means for repeatedly receiving values for the datum representing a parameter of the vehicle 102,
means for determining whether the vehicle has been involved in an accident on the basis of the received values,
means for transmitting, to the telematic computer, an accident report request, if the vehicle has been involved in an accident,
means for receiving an accident report signed and encrypted by the telematic computer,
means for transmitting the signed and encrypted accident report to a remote server 103.

The vehicle 102 comprises at least one onboard computer (not shown), for example a Built-in Systems Interface (BSI) that comprises at least one processor and one memory and manages a certain number of electrical devices of a vehicle and in particular the airbags, interior lights, locking/unlocking of the doors and trunk, operation of the electric windows and sunroof, intermittentency of the wipers, timers and alarm (if any). It also manages the communication between the immobilizer and the engine computer.

The vehicle 102 also comprises a telematic computer 104 comprising means for communicating with devices outside the vehicle. The computer 104 comprises a wireless communication module, for example of the Bluetooth or WIFI type and/or a wired connection, for example of the USB type.

The vehicle 102 also comprises a data bus (not shown), for example a Controller Area Network (CAN) type bus, on which a plurality of computers communicate in turn by exchanging communication frames.

Each frame is identified by a code and contains a set of functional information. The vehicle 102 comprises, for example, an under-inflation detection calculator transmitting frames detailing the status of each wheel (ok, deflated, punctured, etc.). This information is used by other units of the vehicle and can be specifically retrieved by the computer 104.

Advantageously, the vehicle 102 also comprises a camera (not shown) for capturing images (still or moving) of the external environment of the vehicle.

The telematic computer 104 comprises a secure storage space capable of storing a private key used to sign the data transmitted by the computer. The secure storage space is, for example, a Trusted Platform Module (TPM), which is a cryptographic hardware component enabling secrets (such as encryption keys) to be stored securely.

It will be remembered that a certificate (or electronic certificate) is a data set containing at least one public key, at least one identification datum (e.g. a name, usually stored in a Common Name (CN) data field) and at least one private key for signing.

The central server 103 is common to a plurality of vehicles. It comprises a database for storing data from terminals. In practice, the server stores a certain number of data relating to the vehicle (for example the Vehicle Identification Number (VIN)) and to its owner.

The central server 103 has means to decrypt the report encrypted by the computer. The decryption means comprises, for example, a private key. In this case, the accident report is encrypted by the telematic computer 104 using a public key associated with the private key by an asymmetric encryption algorithm.

The invention also relates to a method for commanding the establishment of an accident report. This method, implemented by the terminal 101, comprises the following steps.

Firstly, the method comprises a step 201 for subscribing, in the telematic computer 104 of the vehicle 102, to a data publication service, for at least one datum representing a parameter of the vehicle 102.

The method then comprises a step 202 of repeatedly receiving values for the datum representing a parameter of the vehicle 102. The terminal regularly receives values for one or more data making it possible to determine that an accident has occurred. These data concern, for example: a status of an airbag of the vehicle 102, a status of an electronic stability program of the vehicle 102, a location of the vehicle 102, a timestamp indicating the moment of activation of the airbag or of the electronic stability program, a mileage, a log of alerts, fault codes, a steering wheel angle and a pressure on the brake pedal.

Advantageously, at least one of the transmitted data is associated with a timestamp.

In the next step 203, the terminal 101 determines, on the basis of the received values, whether the vehicle 102 has been involved in an accident.

The terminal 101 comprises a memory in which is stored a list of predefined tests. The tests relate to the data representing a parameter of the vehicle 102. To determine whether the vehicle 102 has been involved in an accident, the terminal checks whether at least one of the tests is verified or if a combination of tests is verified.

Advantageously, the list of predefined tests includes at least one of the following tests:
the air bag of the vehicle 102 is deployed,
the electronic stability program of the vehicle 102,
the pressure on the brake pedal is greater than a first predetermined threshold S1,
the variation of the speed is greater than a second predetermined threshold S2;
the variation of the steering wheel angle is greater than a third predetermined threshold S3.

For example, if the vehicle airbag is deployed then an accident is deemed to have occurred.

Furthermore, if the pressure on the brake pedal is greater than the first predetermined threshold S1 and the variation of the steering wheel angle is greater than the third predetermined threshold S3 then an accident is also deemed to have occurred.

If the vehicle has been involved in an accident, the terminal 101, at step 204, commands the telematic computer 104 to provide an accident report.

In response, the telematic computer 104 transmits an accident report. The report is signed by the telematic computer 104 using the certificate stored in the memory thereof. This guarantees the integrity of the accident report. Advantageously, the report is also encrypted. This guarantees the confidentiality of the accident report.

According to a characteristic of the invention, the report contains at least one of the following data:
a log of alerts to identify problems after the accident,
an overall check of the vehicle comprising a status of the openings and the fluid level,
vehicle fault data,
images captured by a camera mounted on board the vehicle.

Advantageously at least one of the data of the accident report is associated with a timestamp.

The terminal 101, at step 205, receives the accident report signed and encrypted by the telematic computer.

Then, the terminal 101, at step 206, transmits the signed and encrypted accident report to the remote server 103.

The terminal 101 does not decrypt the report and does not check the signature of the report. It is the remote server 103 that decrypts the report and verifies the integrity thereof.

Advantageously, the method also comprises a step 205 of receiving by the terminal 101 a user request for an accident report and in response the transmission, by the terminal 101, to the telematic computer 104, of an accident report request. Thus, the user can request a report on the status of his vehicle without the latter having been involved in an accident.

Advantageously, if, during the step 203 of determining an accident, at least one of the tests is evaluated positively, then the method according to the invention also comprises a step 208 of recording an event in an event log, indicating the test having been evaluated positively.

Advantageously, the method also comprises a step of receiving, by the terminal 101, the decrypted accident report from the remote server 103. The accident report received from the remote server can be read on the terminal 101. The data contained in the report have been checked on the remote server 103. Their integrity is thus guaranteed.

1. A method, implemented by a terminal, for commanding the establishment of a vehicle accident report, from a telematic computer of the vehicle, wherein, the method comprises the steps of:
Subscribing, from the telematic computer of the vehicle, to a data publication service, for at least one datum representing a vehicle parameter,
Repeatedly receiving values for the datum representing a vehicle parameter,
Determining from the received values, whether the vehicle has been involved in an accident,
If the vehicle has been involved in an accident, transmitting to the telematic computer an accident report request,
Receiving an accident report signed and encrypted by the telematic computer, and
Transmitting the signed and encrypted accident report to a remote server.

2. The method for commanding the establishment of an accident report according to claim 1, wherein the terminal comprises a memory in which is stored a list of predefined tests, said tests relating to the data representing a parameter of the vehicle, the step of determining whether the vehicle has been involved in an accident comprises a step of determining whether at least one of the tests is verified or if a combination of tests is verified.

3. The method for commanding the establishment of an accident report according to claim 1, wherein the data representing a vehicle parameter comprises at least one of the following data: a status of an airbag of the vehicle, a status of an electronic stability program of the vehicle, a location of the vehicle, a timestamp indicating the moment of activation of the airbag or of the electronic stability program, a mileage, a log of alerts, fault codes, a steering wheel angle, and a pressure on the brake pedal.

4. The method for commanding the establishment of an accident report according to claim 3, wherein the predefined condition list includes at least one of the following conditions:
the vehicle airbag is deployed,
the pressure on the brake pedal is greater than a first predetermined threshold,
the speed variation is greater than a second predetermined threshold,
the variation of the steering wheel angle is greater than a third predetermined threshold.

5. The method for commanding the establishment of an accident report according to claim 1, wherein the method further comprises a step of receiving a user request, an accident report, and, in response to the request, sending to the telematic computer an accident report request.

6. The method for commanding the establishment of an accident report according to claim 1, wherein, if during the step of determining whether an accident has occurred, at least one of the tests is evaluated positively, the method includes a step of recording an event in an event log, indicating the test having been evaluated positively.

7. The method for commanding the establishment of an accident report according to claim 2, wherein the method further comprises a step of receiving the decrypted accident report from the server.

8. The method for commanding the establishment of an accident report according to claim 1, wherein the accident report contains at least one of the following data:
a log of alerts to identify problems after the accident,
an overall check of the vehicle comprising a status of the openings and the fluid level,
vehicle fault data,
images captured by a camera mounted on board the vehicle.

9. A terminal for commanding the establishment of an accident report of a vehicle, wherein the terminal comprises:
means for subscribing, in a telematic computer of the vehicle, to a data publication service, for at least one datum representing a vehicle parameter,
means for repeatedly receiving values for the datum representing a vehicle parameter,
means for determining whether the vehicle has been involved in an accident on the basis of the received values,
means for transmitting, to the telematic computer, an accident report request, if the vehicle has been involved in an accident,
means for receiving an accident report signed and encrypted by the telematic computer, and
means for transmitting the signed and encrypted accident report to a remote server.

10. A system for establishing a vehicle accident report; the system comprising a telematic computer onboard the vehicle capable of regularly transmitting data, a remote server and a terminal capable of communicating with the telematic computer and with the remote server, wherein:
the telematic computer is capable of transmitting a signed and encrypted accident report;
the terminal is a terminal according to the preceding claim.
